(19) United States
(12) Patent Application Publication
(10) Pub. No.: US 2012/0113059 A1
(43) Pub. Date: May 10, 2012

(54) SIGNAL PROCESSING DEVICE AND ELECTRONIC DEVICE

(75) Inventor: Atsushi Okada, Osaka-shi (JP)

(73) Assignee: Sharp Kabushiki Kaisha, Osaka-shi (JP)

(21) Appl. No.: 13/380,395

(22) PCT Filed: May 21, 2010
(86) PCT No.: PCT/JP2010/058627

§ 371 Date: Dec. 22, 2011

(30) Foreign Application Priority Data
Jun. 23, 2009 (JP) 2009-148747

(51) Int. Cl. G06F 3/042

(52) U.S. Cl. 345/175

(57) ABSTRACT

A signal processing device that can reduce the number of signal lines for outputting sensor signals includes a sensor interface unit that acquires, from a photosensor having multiple pixels, data of the pixels; a coordinate processing unit that generates position data indicating a detected position of a detection target from the data of the pixels; a video processing unit that generates image data in a predetermined format from the data of the pixels; a test mode control unit or switching control unit that switches which of the coordinate processing unit and the video processing unit is to perform processing on the data of the pixels; and a user interface unit that converts the position data generated by the coordinate processing unit and the image data generated by the video processing unit into a serial signal and outputs the serial signal to a serial bus.

### REFERENCE TO RELATED APPLICATIONS

This application is the national stage under 35 USC 371 of International Application No. PCT/JP2010/058627, filed May 21, 2010, which claims the priority of Japanese Patent Application No. 2009-148747, filed Jun. 23, 2009, the entire contents of which are incorporated herein by reference.

### TECHNICAL FIELD

The present invention relates to a signal processing device that can switch between outputting position data and outputting image data.

### BACKGROUND ART

Display panels that include photosensors and touch sensors have become known in recent years (e.g., see JP 2009-16855A). Such display panels are often used in mobile phones and the like. Processes for manufacturing mobile phones and the like include an inspection step for inspecting, for example, the operation performance of various types of sensors provided in the display panel.

Conventional inspection steps have employed a method in which signal lines for inspection are drawn out from the display panel of a mobile phone or the like in advance, and sensor data is input to the processor of the main body via such signal lines, or a method in which many test points are provided in advance on the flexible printed circuit (FPC) that connects the display panel and the main body, and inspection is performed via such test points.

FIG. 6 is a schematic diagram showing the case where signal lines have been drawn out on an FPC 3 from a display panel 1. As shown in FIG. 6, signal lines for an image signal (24 pins), a synchronization signal (2 pins), an image clock (1 pin), an SPI (4 pins), and a sensor signal (12 pins) have been drawn out on the FPC 3 from the display panel 1. The signal line for sensor signals is a signal line for acquiring, as an image, a signal obtained from photosensors in the display panel 1. Specifically, in the case of a touch panel employing photosensors, processing is performed using a signal obtained from the photosensors in the panel, and therefore in the inspection step, the output signal of the photosensors is detected as an image, a photosensor quality determination is made, and adjustment is performed. The display panel 1 that functions as the touch panel employing photosensors therefore needs a signal line for sensor signals such as that described above. For example, in the case where the image data is 10-bit data, a 2-bit control signal is necessary, and therefore it is necessary to draw out a 12-bit signal line as the sensor line for sensor signals.

### SUMMARY OF THE INVENTION

In a situation where there is demand for a reduction in the size and cost of devices such as mobile phones, it is not practical to draw out a signal line for sensor signals in order to be applied in inspection. Also, providing a large number of test points on the FPC does not have broad utility since a special-purpose device for connecting to the test points is necessary, and is not practical from the standpoint of a reduction in size and cost as well.

The present invention has been achieved in light of the above-described issues, and an object thereof is to provide a signal processing device that can reduce the number of signal lines necessary for outputting sensor signals.

In order to achieve the above object, a signal processing device disclosed below includes: a sensor interface unit that acquires, from a photosensor having a plurality of pixels, data of the plurality of pixels; a coordinate processing unit that generates position data indicating a detected position of a detection target from the data of the plurality of pixels acquired by the sensor interface unit; a video processing unit that generates image data in a predetermined format from the data of the plurality of pixels acquired by the sensor interface unit; a switching control unit that switches which of the coordinate processing unit and the video processing unit is to perform processing on the data of the plurality of pixels acquired by the sensor interface unit; and a user interface unit that outputs the position data generated by the coordinate processing unit and the image data generated by the video processing unit to a serial bus as serial data.

According to this configuration, the signal processing device of the present invention has an effect of enabling a reduction in the number of signal lines necessary for outputting sensor signals.

### BRIEF DESCRIPTION OF DRAWINGS

FIG. 1 is an overview diagram of a signal processing device 5 according to an embodiment of the present invention.

FIG. 2 is a functional block diagram showing a configuration of the signal processing device 5 in the case of being incorporated in a display device 10.

FIG. 3 is a timing chart in the case where a sensor interface unit 6 reads scan images.

FIG. 4 is a timing chart related to data generated in a signal processing unit 7.

FIG. 5 is a timing chart related to data output from a user interface unit 8.

FIG. 6 is a schematic diagram in the case where signal lines are drawn out on an FPC 3 from a display panel 1.

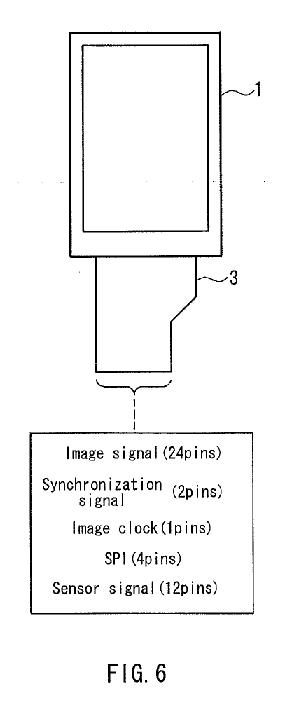

### DETAILED DESCRIPTION OF THE INVENTION

(1) A signal processing device according to an embodiment of the present invention is configured including: a sensor interface unit that acquires, from a photosensor having a plurality of pixels, data of the plurality of pixels; a coordinate processing unit that generates position data indicating a detected position of a detection target from the data of the plurality of pixels acquired by the sensor interface unit; a video processing unit that generates image data in a predetermined format from the data of the plurality of pixels acquired by the sensor interface unit; a switching control unit that switches which of the coordinate processing unit and the video processing unit is to perform processing on the data of the plurality of pixels acquired by the sensor interface unit; and a user interface unit that outputs the position data generated by the coordinate processing unit and the image data generated by the video processing unit to a serial bus as serial data (first configuration).

According to this configuration, switching is performed between which of the coordinate processing unit and the video processing unit is to perform processing on the data of the pixels acquired by the sensor interface unit, and the position data generated by the coordinate processing unit or the image data generated by the video processing unit is output to the serial bus as serial data. The signal processing device can therefore reduce the number of signal lines necessary for outputting sensor signals.

(2) In the first configuration, the serial bus may be an SPI bus (second configuration). According to this configuration, an image signal is output as serial data, and therefore signal lines can be used effectively when outputting data.

(3) In the first or second configuration, the sensor interface unit may acquire the data of the plurality of pixels that has been transmitted by parallel transmission. This configuration enables using the same signal line to output position data and image data based on data input as parallel data.

(4) In any one of the first to third configurations, the user interface unit may receive a switch signal that instructs switching between position data generation and image data generation, and the switching control unit may switch which of the coordinate processing unit and the video processing unit is to perform processing on the data of the plurality of pixels acquired by the sensor interface unit, in accordance with the switch signal (fourth configuration). Also, (5) in the fourth configuration, the switch signal may be a signal indicating whether a current mode is a test mode, and in a case where the switch signal indicates that the current mode is the test mode, the switching control unit may cause the data of the plurality of pixels acquired by the sensor interface unit to be input to the coordinate processing unit (fifth configuration). These configurations enable the output of image data and position data to a signal line to be controlled based on a switch signal from the outside.

(6) In any one of the first to fifth configurations, the user interface unit may receive a clock signal and output the image data as serial data based on the clock signal (sixth configuration). According to this configuration, a clock signal from the host, which is an external device, is added to the image data that is output. For this reason, the display of image data can be easily controlled in the host.

(7) In any one of the first to fifth configurations, the video processing unit may acquire a clock signal from the sensor interface unit, and the user interface unit may output the image data as serial data based on the clock signal (seventh configuration). According to this configuration, a clock signal from the signal processing device is added to the image data that is output. For this reason, the output of image data can be easily controlled in the signal processing device.

(8) In any one of the first to seventh configurations, the video processing unit may generate image data that includes a synchronization signal, and the user interface unit may output the synchronization signal and the image data using different signal lines (eighth configuration). Also, (9) in the eighth configuration, the synchronization signal may include synchronization code (ninth configuration). According to these configurations, a synchronization signal generated in the video processing unit is added to the image data that is output. For this reason, the output of image data can be easily controlled in the signal processing device.

(10) An electronic device according to an embodiment of the present invention is an electronic device having a photosensor, the electronic device including: a sensor interface unit that acquires data of the plurality of pixels from the photosensor; a coordinate processing unit that generates position data indicating a detected position of a detection target from the data of the plurality of pixels acquired by the sensor interface unit; a video processing unit that generates image data in a predetermined format from the data of the plurality of pixels acquired by the sensor interface unit; a switching control unit that switches which of the coordinate processing unit and the video processing unit is to perform processing on the data of the plurality of pixels acquired by the sensor interface unit; a user interface unit that outputs the position data generated by the coordinate processing unit and the image data generated by the video processing unit, as serial data; a main body processing unit that executes processing using the position data or the image data output from the user interface unit; a parallel bus that transmits the data of the plurality of pixels output from the photosensor to the sensor interface unit by parallel transmission; and a serial bus that transmits serial data including the position data and the image data output from the user interface unit, to the main body processing unit by serial transmission (tenth configuration).

(11) In the tenth configuration, the electronic device may further include: a display panel; and a display parallel bus that transmits display data from the main body processing unit to the display panel (eleventh configuration).

Note that in the following description, the present invention is described taking the example of the case of being applied to a display device that has a liquid crystal panel equipped with photosensor functionality. Note also that the present invention can be applied to other display devices as well, such as an organic EL display device or a PDP.

### 1. First Embodiment

[1-1. Overview of Invention]

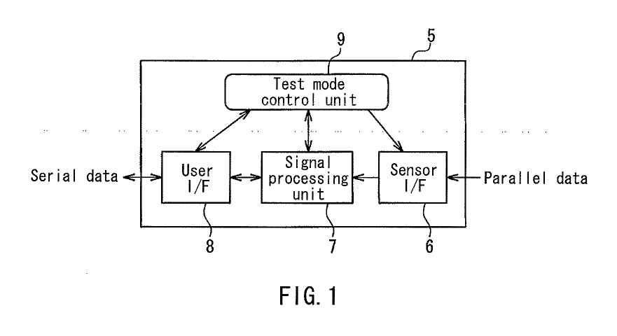

FIG. 1 is an overview diagram of a signal processing device 5 according to the present invention. The signal processing device 5 exists on an FPC that is connected to a display panel. Note that the signal processing device 5 may exist at another position inside an electronic device (e.g., a mobile phone) to which a display panel is mounted. The signal processing device 5 includes at least a sensor interface unit (sensor I/F) 6, a signal processing unit 7, a user interface unit (user I/F) 8, and a test mode control unit 9.

The test mode control unit (switching control unit) 9 receives a signal from an external device for inspection and determines whether the current mode is a test mode. The test mode control unit (switching control unit) 9 causes image data to be output from the user interface unit 8 in the case of the test mode, and causes position data to be output from the user interface unit 8 in the case a non-test mode.

Various types of sensor signals from a photosensor module and the like are input via an A/D converter to the sensor interface unit 6 as parallel data by a parallel bus. Pixel data detected by the photosensors is included among the various types of sensor signals. The signal processing unit 7 performs predetermined signal processing based on the sensor signals acquired from the sensor interface unit 6. In this signal processing, the signal processing unit 7 generates position data based on the sensor signals in the case of the non-test mode, and generates image data based on the sensor signals in the case of the test mode. Using a predetermined signal line, the user interface unit 8 outputs the position data or the image data that was output from the signal processing unit 7, to the external device for inspection as serial data.

[1-2. Application to Display Device]

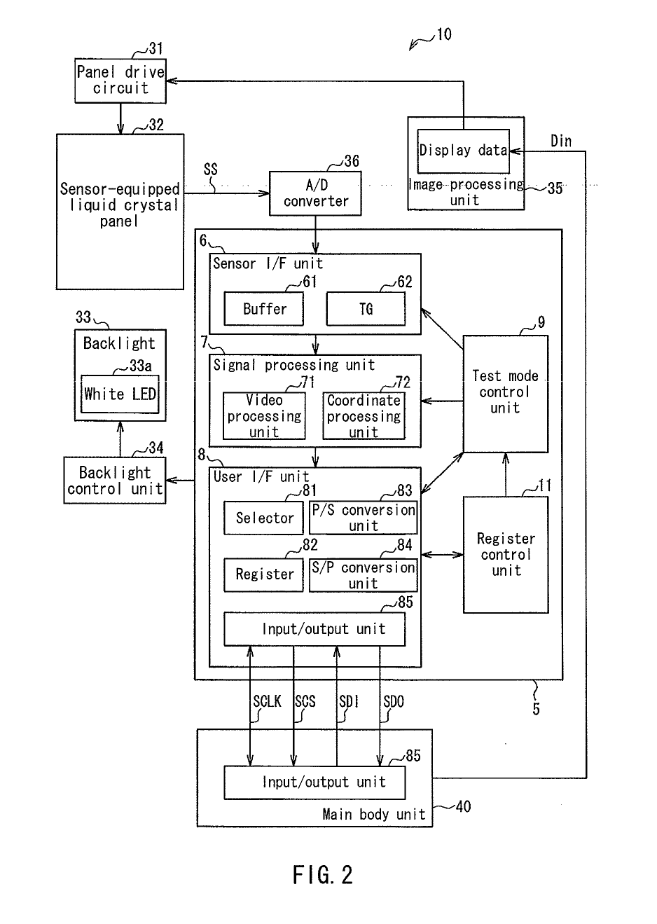

FIG. 2 is a functional block diagram showing a configuration of the signal processing device 5 shown in FIG. 1 in the case of being incorporated in a display device 10. The display device 10 shown in FIG. 2 includes a panel drive circuit 31, a sensor-equipped liquid crystal panel 32, a backlight 33, a backlight control unit 34, an A/D converter 36, an image processing unit 35, the signal processing device 5, and a main body unit 40. This signal processing device 5 is configured by, for example, an LSI including an arithmetic processing device such as a microprocessor unit (MPU).

The sensor-equipped liquid crystal panel 32 includes multiple pixel circuits and multiple photosensors that are arranged two-dimensionally. The image processing device 35 receives an input of display data Din from the main body unit 40 (main body processing unit) via a display parallel bus. The input display data Din is supplied to the panel drive circuit 31 via the image processing unit 35. The panel drive circuit 31 writes voltages corresponding to the display data Din to the pixel circuits of the sensor-equipped liquid crystal panel 32. Accordingly, an image based on the display data Din is displayed by the pixels of the sensor-equipped liquid crystal panel 32.

The backlight 33 includes multiple white light emitting diodes (LEDs) 33a and irradiates the back surface of the sensor-equipped liquid crystal panel 32 with light (backlight light). The backlight control unit 34 switches between supplying and not supplying power supply voltage to the backlight 33 in accordance with a backlight control signal output from the LSI configuring the signal processing device 5.

The sensor-equipped liquid crystal panel 32 outputs a photosensor output signal as a sensor output signal SS. The AID converter 36 converts the analog sensor output signal SS into a digital signal. The output signal of the A/D converter 36 represents a scan image that was sensed by the sensor-equipped liquid crystal panel 32.

The main body unit 40 performs arithmetic processing for the entirety of the display device 10. For example, the main body unit 40 executes an application program using the position data or image data output by the signal processing device 5.

[1-2-1. Sensor Interface Unit]

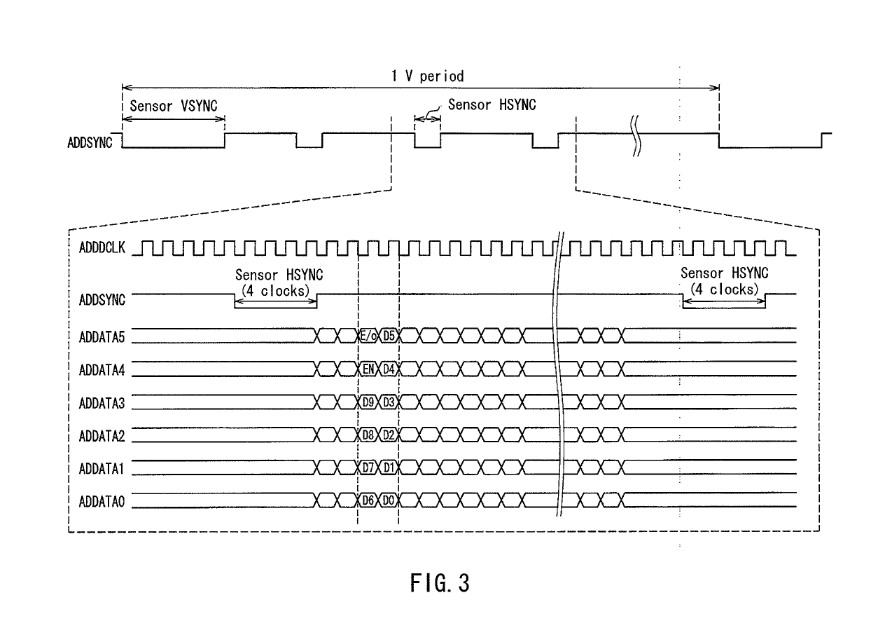

The sensor interface unit 6 of the signal processing device 5 loads, into a buffer 61, a scan image based on the sensor output signal SS that was acquired in a coordinate information sensing period. FIG. 3 is a timing chart showing the timing according to which the sensor interface unit 6 reads scan images output from the A/D converter 36. As shown in FIG. 3, the A/D converter 36 outputs an ADDDCLK signal, an ADDSYNC signal, and ADDATA[5:0]. The ADDDCLK signal is a clock signal, the ADDSYNC signal is a synchronization signal that includes vertical synchronization and horizontal synchronization, and ADDATA[5:0] are an example of pixel data output from the photosensors in the case of parallel transmission of one pixel-worth of data using 12 bits.

The sensor interface unit 6 switches the format of the data output to the signal processing unit 7 based on a switch signal from the test mode control unit 9. Here, as one example, the switch signal is a signal that instructs a switch between the non-test mode in which position data is generated and the test mode in which image data is generated.

The switch signal is generated in a register control unit 11 based on an SDI signal received from the main body unit 40, which functions as an SPI bus host. The register control unit 11 transmits the switch signal to the sensor interface unit 6 via the test mode control unit 9.

[1-2-2. Signal Processing Unit]

The signal processing unit 7 acquires various types of sensor signals from the sensor interface unit 6 and performs predetermined signal processing thereon. For example, in the non-test mode, the signal processing unit 7 determines a touch position based on a scan image acquired by performing A/D conversion on the sensor output signal, and outputs the touch position as position data. On the other hand, in the test mode, the signal processing unit 7 outputs time-series image data (video data) based on scan images acquired by performing A/D conversion on the sensor output signal, along with the synchronization signal

[1-2-2-1. Non-test Mode for Position Data Generation]

First, the non-test mode in which position data is generated will be described. In the case of generating position data, the sensor interface unit 6 outputs acquired data of multiple pixels as data in a format for processing by a coordinate processing unit 72.

The sensor interface unit 6 of the signal processing device 5 outputs, to the coordinate processing unit 72 of the signal processing unit 5, a scan image corresponding to one frame that was loaded into the buffer 61. The coordinate processing unit 72 receives such output and specifies a touch position based on the values of the data of each pixel constituting the scan image. Thereafter, the coordinate processing unit 72 acquires position data that corresponds to the specified touch position, and outputs the acquired position data to the user interface unit 8.

A selector 81 of the user interface unit 8 receives a control signal from the test mode control unit 9, and loads the position data from the signal processing unit 7 into a register 82. The position data that was loaded into the register 82 is output by a P/S conversion unit 83 of the user interface unit 8 to the main body unit 40, which is an external device, as serial data via a signal line SDO of an input/output unit 85. In other words, the position data is input to the main unit 40 via a serial bus.

[1-2-2-2. Test Mode for Image Data Generation]

Next, the test mode in which image data is generated will be described. In the case of generating image data, the sensor interface unit 6 outputs acquired data of multiple pixels as data in a format for processing by a video processing unit 71.

The sensor interface unit 6 of the signal processing device 5 outputs the scan images loaded into the buffer 61 to the signal processing unit 7 frame-by-frame in time-series. The sensor interface unit 6 also outputs, to the signal processing unit 7, the ADDDCLK signal and the ADDSYNC signal, which is a synchronization signal, that are output along with the scan images (ADDATA[0:5]) from the A/D converter 36.

A TG 62 of the sensor interface unit 6 controls the loading of data into the buffer 61 based on the ADDSYNC signal or the ADDDCLK signal that are output along with the scan images from the A/D converter 36. The TG 62 also generates synchronization code based on the ADDSYNC signal or the ADDDCLK signal, and inserts the generated synchronization code at appropriate positions in the image data representing the scan images.

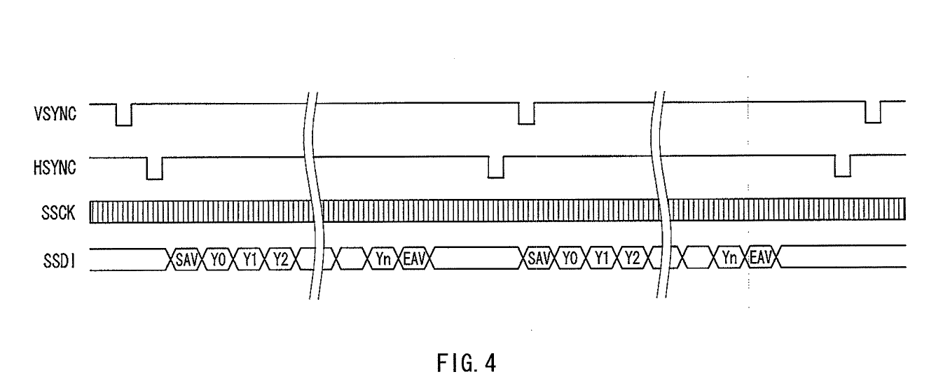

FIG. 4 is a timing chart related to data generated in the signal processing unit 7. The TG (Timing Generator) 62 of the sensor interface unit 6 outputs a VSYNC signal, an HSYNC signal, and an SSCK signal based on the ADDSYNC signal and the ADDDCLK signal. Here, the VSYNC signal is a vertical synchronization signal, the HSYNC signal is a horizontal synchronization signal, and the SSCK signal is a clock signal. Also, an SAV (Start of Active Video) and an EAV (End of Active video) are inserted as synchronization code into an SSDI signal including image data. Here, the SAV is code representing the start of a frame, and the EAV is code representing the end of a frame.

[1-2-3. User Interface Unit]

The signal processing unit 7 outputs, to the user interface unit 8, the image data that was generated in the video processing unit 71 and includes synchronization code. The selector 81 of the user interface unit 8 loads the image data from the signal processing unit 7 into the register 82 based on the switch signal from the test mode control unit 9 and the control signal from the register control unit 11. Here, the register control unit 11 performs setting value management, operation control, and control of state reading and the like for the entirety of the signal processing device 5.

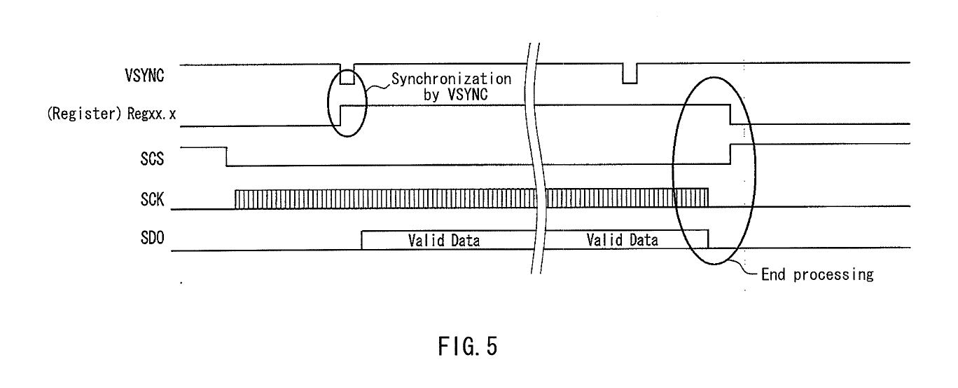

FIG. 5 is a timing chart related to data output from the user interface unit 8. As shown in FIG. 5, the image data that was loaded into the register 82 as a parallel signal is output by the P/S conversion unit 83 of the user interface unit 8 as an SDO signal (serial data) in synchronization with the VSYNC signal. Accordingly, the image data is transmitted by serial transmission to the main body unit 40 as the SDO signal of an SPI (Serial Peripheral Interface) bus, which is a serial bus standard. In FIG. 5, “Valid Data” corresponds to the image data that is transmitted by serial transmission.

Note that an S/P conversion unit 84 receives an SCLK signal, an SCS signal, and an SDI signal from the main body unit 40, which functions as an SPI bus host, and transmits the received signals to the register control unit 11. Here, the SCLK signal is a clock signal transmitted from the SPI bus host, and the SCS signal is a chip select signal transmitted from the same host.

As described above, according to the present embodiment, in the test mode, image data is output using the same signal line as that for position data by switching from position data, thus enabling reducing the number of signal lines necessary for outputting signals. This eliminates the need to draw out a signal line to be used only for the inspection of sensor images from a mobile phone or the like.

### 2. Other Embodiments

Although embodiments of the present invention have been described above, the present invention is not limited to the above-described embodiments, and various types of modifications can be made within the scope of the invention.

[2-1. Changing of Clock Signal]

When outputting the SDO signal of the SPI bus, an SSCK signal from a sensor may be used instead of the SCLK signal from the main body unit 40. This eliminates the need to generate image data in conformity with the SCLK signal and enables effectively controlling various types of processing without causing data overflow or under-flow.

[2-2. Inspection and Checking]

The image data output from the input/output unit 85 to the main body unit 40 as an SDO signal may be input to the image processing unit 35 as the display data Din. This enables the image data to be displayed on the sensor-equipped display panel 32 and be visually inspected and checked. Also, an inspection result may be obtained by quantifying and analyzing the color-difference signal (Y data) included in the image data.

The present invention is useful to a device that has a function of inputting and outputting sensor signals.

1. A signal processing device comprising:
a sensor interface unit that acquires, from a photosensor having a plurality of pixels, data of the plurality of pixels;
a coordinate processing unit that generates position data indicating a detected position of a detection target from the data of the plurality of pixels acquired by the sensor interface unit;
a video processing unit that generates image data in a predetermined format from the data of the plurality of pixels acquired by the sensor interface unit;
a switching control unit that switches which of the coordinate processing unit and the video processing unit is to perform processing on the data of the plurality of pixels acquired by the sensor interface unit; and
a user interface unit that outputs the position data generated by the coordinate processing unit and the image data generated by the video processing unit to a serial bus as serial data.

2. The signal processing device according to claim 1, wherein the serial bus is an SPI bus.

3. The signal processing device according to claim 1, wherein the sensor interface unit acquires the data of the plurality of pixels that has been transmitted by parallel transmission.

4. The signal processing device according to claim 1,
wherein the user interface unit receives a switch signal that instructs switching between position data generation and image data generation, and
the switching control unit switches which of the coordinate processing unit and the video processing unit is to perform processing on the data of the plurality of pixels acquired by the sensor interface unit, in accordance with the switch signal.

5. The signal processing device according to claim 4,
wherein the switch signal is a signal indicating whether a current mode is a test mode, and
in a case where the switch signal indicates that the current mode is the test mode, the switching control unit causes the data of the plurality of pixels acquired by the sensor interface unit to be input to the coordinate processing unit.

6. The signal processing device according to claim 1, wherein the user interface unit receives a clock signal and outputs the image data as serial data based on the clock signal.

7. The signal processing device according to claim 1,
wherein the video processing unit acquires a clock signal from the sensor interface unit, and
the user interface unit outputs the image data as serial data based on the clock signal.

8. The signal processing device according to claim 1,
wherein the video processing unit generates image data that includes a synchronization signal, and
the user interface unit outputs the synchronization signal and the image data using different signal lines.

9. The signal processing device according to claim 8, wherein the synchronization signal includes synchronization code.

10. An electronic device having a photosensor, the electronic device comprising:
a sensor interface unit that acquires data of the plurality of pixels from the photosensor;
a coordinate processing unit that generates position data indicating a detected position of a detection target from the data of the plurality of pixels acquired by the sensor interface unit;
a video processing unit that generates image data in a predetermined format from the data of the plurality of pixels acquired by the sensor interface unit;
a switching control unit that switches which of the coordinate processing unit and the video processing unit is to perform processing on the data of the plurality of pixels acquired by the sensor interface unit;
a user interface unit that outputs the position data generated by the coordinate processing unit and the image data generated by the video processing unit, as serial data;
a main body processing unit that executes processing using the position data or the image data output from the user interface unit;
a parallel bus that transmits the data of the plurality of pixels output from the photosensor to the sensor interface unit by parallel transmission; and
a serial bus that transmits serial data including the position data and the image data output from the user interface unit, to the main body processing unit by serial transmission.

11. The electronic device according to claim 10, further comprising:
a display panel; and
a display parallel bus that transmits display data from the main body processing unit to the display panel.
